(19) United States
(12) Patent Application Publication
(10) Pub. No.: US 2014/0156248 A1
(43) Pub. Date: Jun. 5, 2014

(54) TRANSIENT SIMULATION METHOD FOR A PHOTODIODE

(71) Applicant: STMICROELECTRONICS SA, MONTROUGE (FR)

(72) Inventor: JEAN-ROBERT MANOUVRIER, ECHIROLLES (FR)

(73) Assignee: STMICROELECTRONICS SA, MONTROUGE (FR)

(21) Appl. No.: 14/084,727

(22) Filed: Nov. 20, 2013

(30) Foreign Application Priority Data
Nov. 30, 2012 (FR) 1261447

(51) Int. Cl. G06F 17/50

(52) U.S. Cl. CPC G06F 17/5009
USPC 703/13

(57) ABSTRACT

A simulation method for a P-I-N junction photodiode uses a model that may include a diode model configured to characterize electrical behavior of the P-I-N junction photodiode, and an input for applying a fictitious electrical signal representing optical power received by the P-I-N junction photodiode. A current source model may be coupled to the diode model and may have a transient response to a variation of the fictitious electrical signal, based upon a sum of a first first-order transient response with a time constant based upon to a transit time of carriers in a depletion region of the P-I-N junction, and a second first-order transient response with a time constant based upon a diffusion time of carriers outside of the depletion region. The first and second responses may be respectively weighted by a length of the depletion region and a length of the P-I-N junction outside the depletion region.

### FIELD OF THE INVENTION

The invention relates to the simulation of optoelectronic components, such as photodiodes.

### BACKGROUND OF THE INVENTION

In the field of electronic components, so-called compact simulation models may be used. A compact model is a model that provides a directly usable output quantity that is a function of an input variable and a set of parameters. SPICE models of electrical components, for example, are compact models.

Optoelectronic components involve electrical and optical quantities. It may be desirable for a photodiode to have a compact model that expresses the photocurrent according to the optical power received by the photodiode, the optical power being supplied to the model in the form of a fictitious electrical quantity.

FIG. 1 is a perspective view of a measuring unit inserted in a optical waveguide, for example at one end of the waveguide. The waveguide has an inverted “T” cross-section, and it carries an optical power P_{IN}. Upon reaching the measuring unit, the waveguide 10 tapers out to connect to a base 12 of a larger section, or width, than that of the waveguide. The enlarged central portion of the base bears a photodiode 14. The cathode C and anode A contacts of the photodiode are arranged parallel to the axis of the waveguide.

FIG. 2 is a sectional view of the photodiode 14 perpendicular to the axis of the waveguide. The photodiode is made of a semiconductor material of the same nature as that forming the base 12, often germanium. It includes a P-doped region at the anode contact A, and an N-doped region at the cathode contact C. The central area between areas P and N is intrinsic or lightly P-doped so as to form a P-I-N junction.

Such a photodiode is commonly used in reverse bias, that is to say, by applying the ‘+’ of the bias voltage to the cathode C and the ‘−’ to the anode A. With this configuration, the response speed of the photodiode increases with the bias voltage, at the expense, however, of an increase of the dark current.

In steady state, for a constant optical power, the photocurrent is proportional to the optical power. The proportionality coefficient is defined as the responsivity of the photodiode, expressed in amperes per watt and denoted by R. The responsivity depends on the wavelength and the physical configuration of the photodiode and is independent of the electrical parameters of the photodiode, such as the bias voltage.

Under transient conditions, it is recognized that this type of photodiode has two different behaviors depending on the value of the bias voltage. For higher bias voltages, it has been shown by S. M. Sze (Physics of Semiconductor Devices, Chapter 13, Photodetectors) that the transient response is approximated by a first order response with a time constant τₐ given by:

$${τ}_{a} = \frac{{τ}_{DRIFT}}{2.4}$$

where τ_{DRIFT} is the transit time of the carriers in the depletion layer created by the reverse bias. This transit time is given by:

$${τ}_{DRIFT} = \frac{{L}_{D}}{v} \qquad ( 1 )$$

where L_{D} is the length of the depletion region and v the velocity of the carriers, approximated by the saturation velocity vₛₐₜ when the electric field is high, which is the case for the intended values of the bias voltage in the current operating mode.

Thus, the photocurrent under transient conditions is expressed by:

$$\begin{matrix}{I}_{phot} ( p ) = \cdot {P}_{IN} ( p ) \cdot H ( p , \frac{{τ}_{DRIFT}}{2.4} ) \\ = \cdot {P}_{IN} ( p ) \frac{1}{1 + p \frac{{τ}_{DRIFT}}{2.4}}\end{matrix}$$

here p is the Laplace operator and H(p,τ) a transient response of first order with a time constant τ:

$$H ( p , τ ) = \frac{1}{1 + p τ}$$

For bias voltages close to 0, the transient response is approximated by a first-order response with a time constant equal to the diffusion time τ_{DIFF} of the carriers in the junction outside the depletion region.

For intermediate bias voltages, the transient response of the photodiode has not been equated satisfactorily. Chapter 2 of the Opto-Semiconductor Handbook from the Hamamatsu Company, suggests the use of a time constant equal to the mean square of the transmission time, the transit time, and an RC time constant, the latter taking into account the load resistance, the junction capacitance, and the packaging capacitance.

### SUMMARY OF THE INVENTION

It may be desirable for a transient simulation method for a photodiode, enabling a relatively simple and accurate simulation of the behavior of the photodiode throughout the variation range of the bias voltage. This desire may be addressed by a simulation model for a P-I-N junction photodiode. The simulation model may include a diode model characterizing the electrical behavior of the photodiode. An input may apply a fictitious electrical signal representing an optical power received by the photodiode. A current source model may have a transient response to a variation of the optical power signal, proportional to the sum of a first first-order transient response with a time constant proportional to the transit time of carriers in a depletion region of the junction, and a second first-order transient response with a time constant proportional to the diffusion time of carriers outside of the depletion region. The first and second order transient responses may be respectively weighted by the length of the depletion region and the length of the junction outside the depletion region.

According to an embodiment, the length of the depletion region is expressed from a capacitance value of the junction. The model may include a Schottky diode model connected between the diode model and a cathode terminal.

A simulation method for a P-I-N junction photodiode may include the steps of providing a diode model characterizing the electrical behavior of the photodiode and determining the junction capacitance of the photodiode as a function of the bias voltage of the photodiode from the diode model. The method may also include determining the length of a depletion region of the junction from the junction capacitance, and determining the transit time of carriers in the depletion region as a function of the bias voltage and the length of the depletion region. The method may also include determining the diffusion time of carriers outside the depletion region as a function of the length of the junction outside the depletion region and defining the transfer function between the optical power and the photocurrent of the photodiode to be proportional to the sum of a first first-order transient response with a time constant proportional to the transit time, and a second first-order transient response with a time constant proportional to the diffusion time. The first and second order transient responses may be respectively weighted by the length of the depletion region and the length of the junction outside the depletion region.

### BRIEF DESCRIPTION OF THE DRAWINGS

FIG. 1 is a schematic perspective view of a measuring unit arranged in a optical waveguide in accordance with the prior art.

FIG. 2 is a schematic sectional view of a photodiode of the measuring unit of FIG. 1.

FIG. 3 is a simplified schematic diagram of a transient model for a photodiode in accordance with the claimed invention; and

FIG. 4 is a graph of response curves produced by using the model of FIG. 3 for various bias voltage values.

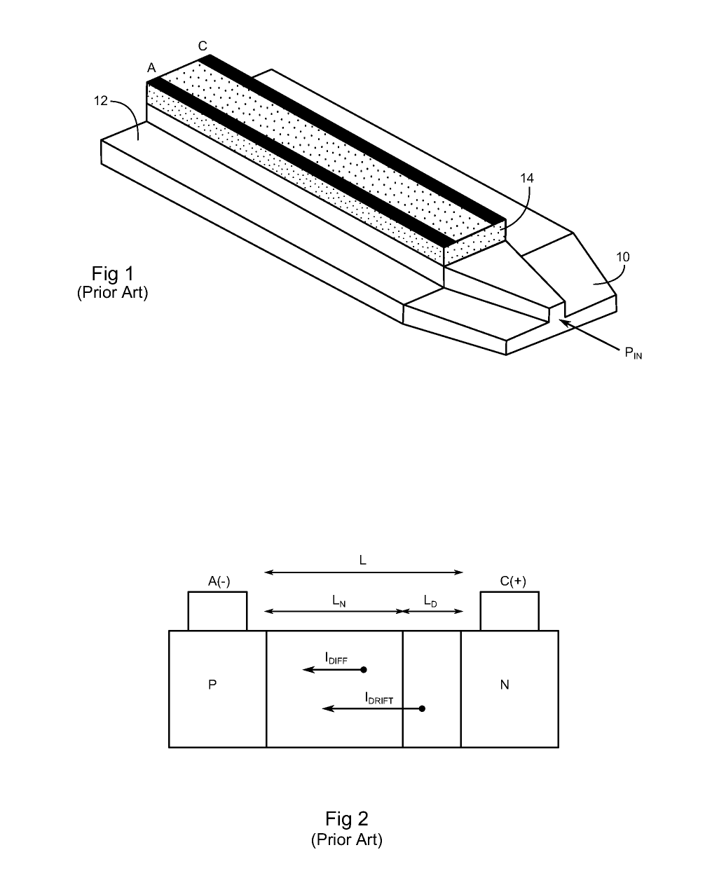

### DETAILED DESCRIPTION OF THE PREFERRED EMBODIMENTS

To develop a transient simulation model for a photodiode, it is assumed in the present disclosure that the photocurrent Iₚₕₒₜ is equal, at any time, to the sum of a diffusion current I_{DIFF} and a drift current I_{DRIFT},—see for example, FIG. 2—the drift current originating in a depletion zone of length L_{D}, and the diffusion current originating in the neutral zone outside the depletion region, of a complementary length L_{N}=L−L_{D}.

It is further assumed that the influence of the drift and diffusion currents are weighted by the lengths of the depletion region and the neutral zone. Thus these currents are expressed in the steady state as:

$${I}_{DRIFT} = {P}_{IN} \frac{{L}_{D}}{L}$$

$${I}_{DIFF} = {P}_{IN} \frac{{L}_{N}}{L}$$

Such that Iₚₕₒₜ=I_{DRIFT}+I_{DIFF}=RP_{IN}.

Each of the currents I_{DRIFT} and I_{DIFF} is considered to have a first order transient response to a variation of the optical power, with a respective time constant τₐ (τ_{DRIFT}/2,4) and τ_{DIFF}. In other words:

$${I}_{phot} ( p ) = {P}_{IN} ( p ) ( \frac{{L}_{D}}{L} H ( p , \frac{{τ}_{DRIFT}}{2.4} ) + \frac{{L}_{N}}{L} H ( p , {τ}_{DIFF} ) ) \qquad ( 2 )$$

The time constant τ_{DIFF} is given by:

$${τ}_{DIFF} = \frac{{( {L}_{N} )}^{2}}{2 D}$$

D is the diffusion coefficient: D=μ₀V_{T}, where μ₀ is the minority carrier mobility and V_{T} the thermal voltage.

The time constant τ_{DRIFT} is expressed by the equation (1) above. In this equation (1), the velocity v is expressed by its exact relationship:

$$v = \frac{{μ}_{0} {E}_{D}}{1 + \frac{{μ}_{0} {E}_{D}}{{v}_{sat}}}$$

where E_{D} is the electric field in the depletion layer, expressed by the equation:

$${E}_{D} = \frac{V}{{L}_{D}} {( 1 - \frac{V}{{V}_{bi}} )}^{1 - MJ}$$

where MJ is the junction gradient index.

The lengths L_{D} and L_{N} remain to be determined. The length L_{D} is the length of the depletion region, a function of the reverse bias voltage of the photodiode. This length is calculated using the parameters extracted for a diode model characterizing the pure electrical behavior of the photodiode, i.e. regardless of optoelectronic phenomena. From this diode model, the junction capacitance can be determined such that:

$${C}_{J} = \frac{{C}_{j 0}}{{( 1 - \frac{V}{{V}_{bi}} )}^{MJ}}$$

where Cⱼ₀ is the zero bias voltage capacitance, parameter extracted for the diode model.

The junction capacitance may also be expressed as:

$${C}_{j} = H \cdot W \frac{{ɛ}_{0} {ɛ}_{r}}{{L}_{D}}$$

where H and W are respectively the height and width, constants, of the intrinsic region of the photodiode. The product ∈₀∈ᵣ expresses the dielectric permittivity of the intrinsic region. These two relationships allow the length L_{D} of the depletion region to be expressed as a function of the bias voltage V.

The length L of the intrinsic region, being a constant, follows L_{N}=L−L_{D}, yielding the weighting factors and time constants for use in equation (2). The resistance of the neutral zone is in turn determined as a function of the length L_{N} from the following relationship:

$${R}_{N} = ρ \frac{{L}_{N}}{H \cdot W}$$

where ρ is the resistivity of the material of the neutral zone. The product R_{N}Cⱼ equals the electrical time constant τ_{RC} of the device.

This time constant is usually relatively small compared to the time constants τ_{DRIFT} and τ_{DIFF} characterizing the photocurrent. However, it may serve for a more accurate global simulation of the photodiode inserted in its application circuitry.

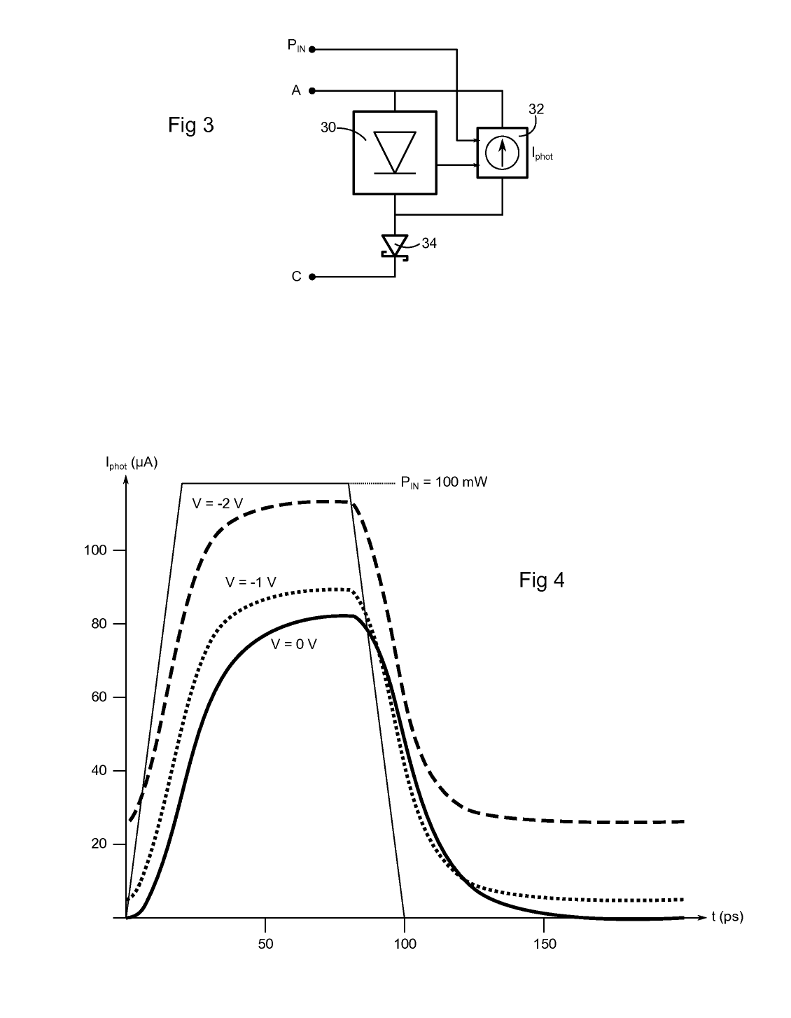

FIG. 3 is a simplified schematic diagram of a transient simulation model of a photodiode based upon the above teachings. The model includes a diode model 30 characterizing the electrical behavior of the photodiode, connected between the anode and cathode terminals A, C. The diode model 30 may be conventional and does not take the optoelectronic phenomena into account.

A current source model 32 is connected in parallel with the diode model 30 to establish the photocurrent Iₚₕₒₜ from the cathode to the anode. This model receives the optical power P_{IN} on a dedicated terminal in the form of a variable fictitious electrical signal. The current source model produces the current Iₚₕₒₜ using the transfer function (2) with the parameters of diode model 30, in particular the junction capacitance Cⱼ, for determining the lengths L_{D} and L_{N} and the time constants.

To improve the photodiode model, a Schottky diode model 34 may be connected between the model 30 and the cathode terminal C. Indeed, where a germanium photodiode is used, the cathode contact C (FIG. 2) is achieved in practice by depositing tungsten on the N-doped area, creating a Schottky junction.

FIG. 4 illustrates response curves produced using an exemplary photodiode model of the type of FIG. 3 for different values of the bias voltage V, i.e. 0, −1 and −2V. The optical power P_{IN} exhibits a trapezoidal pulse having a 100 mW amplitude and a 100 ps duration. This optical power signal is provided to the model in the form of a current signal having a 100 μA amplitude, for example.

It may be noted that the slopes of the response curves increase with the absolute value of the bias voltage resulting in the expected increase in response speed as a function of the reverse bias. It may also be noted that the lower bound of the response curves increases with the absolute value of the bias voltage reflecting the expected increase in dark current. The photodiode model also takes temperature into account since the temperature intervenes in the expressions of the internal voltage V_{bi} and of the thermal voltage V_{T}.

1-4. (canceled)

5. A simulation model for a P-I-N junction photodiode and comprising:
a diode model configured to characterize electrical behavior of the P-I-N junction photodiode;
an input configured to apply a fictitious electrical signal representing optical power received by the P-I-N junction photodiode; and
a current source model coupled to the diode model and configured to have a transient response to a variation of the optical power based upon a sum of a first first-order transient response with a time constant based upon a transit time of carriers in a depletion region of the P-I-N junction, and a second first-order transient response with a time constant based upon a diffusion time of carriers outside of the depletion region, respectively weighted by a length of the depletion region and the length of the P-I-N junction outside the depletion region.

6. The model according to claim 5, wherein said current source model is configured to have the transient response to the variation of the optical power proportional to the sum of the first first-order transient response with the time constant proportional to the transit time of carriers in the depletion region of the P-I-N junction, and the second first-order transient response with the time constant proportional to the diffusion time of carriers outside of the depletion region.

7. The model according to claim 5, wherein the length of the depletion region is expressed from a capacitance value of the P-I-N junction.

8. The model according to claim 5, further comprising a Schottky diode model coupled between said diode model and a cathode terminal.

9. A simulation method for a P-I-N junction photodiode comprising:
using a diode model to characterize electrical behavior of the P-I-N junction photodiode;
applying a fictitious electrical signal at an input representing optical power received by the P-I-N junction photodiode; and
using a current source model coupled to the diode model and having a transient response to a variation of the optical power based upon a sum of a first first-order transient response with a time constant based upon a transit time of carriers in a depletion region of the P-I-N junction, and a second first-order transient response with a time constant based upon a diffusion time of carriers outside of the depletion region, respectively weighted by a length of the depletion region and the length of the P-I-N junction outside the depletion region.

10. The method according to claim 9, wherein using the current source model comprises using the current source model having the transient response to the variation of the optical power proportional to the sum of the first first-order transient response with the time constant proportional to the transit time of carriers in the depletion region of the P-I-N junction, and the second first-order transient response with the time constant proportional to the diffusion time of carriers outside of the depletion region.

11. The method according to claim 9, wherein the length of the depletion region is expressed from a capacitance value of the P-I-N junction.

12. A simulation method for a P-I-N junction photodiode comprising:
characterizing electrical behavior of the P-I-N junction photodiode using a diode model;
determining a junction capacitance of the P-I-N junction photodiode based upon a bias voltage of the P-I-N junction photodiode from the diode model;
determining a length of a depletion region of the P-I-N junction from the junction capacitance;
determining a transit time of carriers in the depletion region based upon the bias voltage and the length of the depletion region;
determining a diffusion time of carriers outside the depletion region based upon a length of the P-I-N junction outside the depletion region; and
defining a transfer function between optical power and photocurrent of the P-I-N junction photodiode to be based upon a sum of a first first-order transient response with a time constant based upon the transit time, and a second first-order transient response with a time constant based upon the diffusion time, respectively weighted by at least one of the length of the depletion region and the length of the junction outside the depletion region.

13. The method of claim 12, wherein determining the diffusion time of carriers outside the depletion region comprise determining the diffusion time of carries outside the depletion region as a function of the length of the P-I-N junction outside the depletion region.

14. The method of claim 12, wherein defining the transfer function comprises defining the transfer function between the optical power and the photocurrent of the P-I-N junction photodiode to be proportional to a sum of a first first-order transient response with the time constant proportional to the transit time, and a second first-order transient response with a time constant proportional to the diffusion time.
